(19) United States
(12) Patent Application Publication
(10) Pub. No.: US 2004/0031839 A1
(43) Pub. Date: Feb. 19, 2004

(54) Clip applicator tool

(75) Inventor: Thomas Pruyne, Gurnee, IL (US)

Correspondence Address: FITCH EVEN TABIN AND FLANNERY, 120 SOUTH LA SALLE STREET, SUITE 1600, CHICAGO, IL, 60603-3406, US

(73) Assignee: Stanley Fastening Systems, L.P.

(21) Appl. No.: 10/223,057

(22) Filed: Aug. 16, 2002

(51) Int. Cl. B25C 1/04

(52) U.S. Cl. 227/130

(57) ABSTRACT

A power tool for driving fasteners is provided that includes rear housing and forward head portions with a piston in the rear housing and a fastener driver in the head portion. The rear housing preferably includes a cap member and a housing member with movement of a fluid admission valve split between both to keep size of the cap member to a minimum. Further, guide surfaces for the fluid admission valve member can be integrated into the cap and housing members to avoid having a separate valve body therefor. The forward head portion has light weight outer walls and at least one high strength bearing insert for taking the high loads generated by the tool drive assembly including the driver thereof. In one preferred form, the tool employs both the above-described rear cylinder and forward head portions to provide a balanced, light weight hand-held tool that is ergonomical to use.

### FIELD OF THE INVENTION

The invention relates to power tools for driving fasteners and, more particularly, to hand-held pneumatic tools for clinching clips about wires.

### BACKGROUND OF THE INVENTION

Hand-held clip applicator tools of the type disclosed in U.S. Pat. Nos. 3,641,656 and 5,661,899 are known for clinching clips about a pair of wires. The clips generally are U-shaped and have split prongs on one leg and a single prong on the other leg. The tool driver and anvil are configured so that with wires disposed therebetween, the driver can force the clip against the anvil to wrap the clip legs around the wires with the single prong leg fitting between the prongs of the double prong leg thereby securely holding the wires together.

These clip applicator tools generally have an L-shaped configuration including a rear power cylinder portion and a forward head portion with a neck down area between the cylinder and head portions at which an operator can grip the tool. An air line coupling is provided at the back of the cylinder housing so that in the normal use position, the piston cylinder extends generally horizontally while the head portion including the clip driver has a forward depending portion that extends generally vertically downward to a forward, bottom nose from which the driver is extended for clinching the clips. A toggle linkage between the piston shaft and the driver provides a high output force for the driver, e.g. 2500 pounds. Thus, current commercial clip applicator tools have a relatively heavy head portion for taking the loads generated by the driving action of the piston, toggle linkage and clip driver. More particularly, the head portion of the tools have distinct steel side plates and top and front plates such as can be seen in the tools of the aforementioned patents. As is apparent, the heavy weight of the tool head portion is primarily due to the steel construction of the four plates thereof.

The plates of the head portion of the prior tools are held together by bolting. Despite the high strength steel material utilized with the plates, the great stress placed in the assembled plates by the high forces generated by the camming action in the drive assembly between the piston and driver plunger via the toggle linkage tends to concentrate the loading on the bolts and the very localized surrounding areas. The bolts are machined to high precision tolerances and fit in transverse openings in the front plate extending through the plate across its width and into aligned holes in either side plate with the bolt head and nut clamped thereagainst, respectively. These discrete stress points at the bolts provide places where cracking of the plates occurs, particularly on the front plate.

In this regard, the lower end of the front plate at the nose of the tool head portion also is subject to high loading as the driver is extended and pushes the metal clips against the anvil. The relatively large distance between the lowermost load bearing bolt and the nose end of the front plate creates a very large lever arm with the high loading often causing the plate to break along the lower portion thereof.

Referring specifically to the tool of the '656 patent, like the forward head portion the rear cylinder assembly also is of a relatively large and heavy construction and includes a main housing or casing in which the piston is pneumatically driven, and a separate cap member that closes off the rear open end of the housing. The cap member has a large raised portion in which an air admission valve assembly is received. The valve assembly includes a valve body having a valve member that oscillates therein based on operation of the actuator trigger of the tool.

The cap member raised portion has an annular bore machined therein for receipt of the valve body for the air admission valve unit. Windows are also machined in the annular bore surface to form porting for the pressurized air to and from the tool housing assembly. The valve body is provided with an elongate cylindrical portion sized to have a close fit with the bore annular surface, transverse slots that correspond with the cap member ports, and annular grooves for receipt of O-rings that seal the respective ports from each other with the valve member body assembled into the cap member bore.

These seals eventually wear and need to be replaced which is undesirable from a tool maintenance standpoint. Further, it has been found that during assembly of the valve body into the cap bore, the O-rings can get nicked or notched as they slide past the sharp edge corner surfaces of the port window slots. These damage points in the seal rings create weakness and wear sites with the potential for air leakage requiring seal replacement.

Another consideration is the speed at which the piston is driven by the pressurized air supplied to the air chamber in the housing, and how fast the air can be exhausted therefrom. In the tool of the '656 patent, the pathway for the air undergoes several directional changes between the ports, and the housing chamber and as it travels through the cap raised portion and the valve body. Each directional change lessens the speed at which the air is admitted and exhausted front the housing, thus slowing the movement of the piston and reducing cycle times of the clip driver in both its drive and return strokes.

To integrate the valve assembly in the cap member along with the circuitous air flow path formed therein, the caps of prior tools have a relatively large mass, especially in the axial direction of the valve member oscillating movement. As mentioned, the heavy construction of this large cap member and housing of the cylinder assembly along with the rearwardly extending steel clip magazine makes the rear portion of the tool relatively heavy similar to the forward head portion of the tool so that the overall tool weight is very heavy, e.g. 7½ lbs, despite being generally weight balanced at the forward and rear portions thereof. As these pneumatic clip applicators are hand-held tools, the excessive weight can become a hindrance to prolonged use thereof. Another commercial hand-held, clipping tool has attempted to reduce tool weight by employing plastic housing and cap members for the rear cylinder assembly. While effective in reducing the weight at the rear portion of the tool, this tool still employs the standard steel plate construction of the front head portion thus resulting in a very imbalanced tool, and one that is still prone to damage at the tool head. This imbalanced tool requires that an operator compensate for its forward weighting and center of gravity during operation of the tool reducing tool ergonomics accordingly.

Accordingly, there is a need for a power tool such as a hand-held, pneumatic clip applicator that provides better tool ergonomics for an operator. In addition, a pneumatic clipping tool having high speed driving cycles thereof is desired. It is also desirable that the pneumatic clipping tool have a robust head portion to avoid stress cracking and breakage thereof.

### SUMMARY OF THE INVENTION

In accordance with the present invention, a power tool for driving fasteners, preferably in the form of a hand-held, pneumatic clipping tool is provided which is constructed, in one form, to reduce the size thereof. The reduced size is beneficial in many aspects, one of which is that the tool can be made to be lighter weight for improved ergonomics.

More specifically, the tool utilizes a power cylinder or housing assembly which preferably has a housing for a pneumatically driven piston, and a cap member for closing off an open back end of the housing, although it should be recognized that other housing assembly constructions besides the preferred two-piece cylinder assembly could be implemented in the tool herein. To keep the size of the housing assembly to a minimum, the air admission valve is arranged such that the movement thereof is split between both the cap member and the housing member. Unlike prior tools which have the valve unit entirely within the cap member thus necessitating a larger cap size in the direction of valve movement, the present tool integrates the valve assembly into both the cap member and the housing member, thus allowing for a reduction in size of the cap member, and particularly the portion thereof that houses the valve, as it no longer needs to be as large in the axial direction of valve travel.

To obviate the need for a separate valve body in which the valve member is shifted, the housing assembly has integral guide surfaces along which the valve member is shifted between intake and exhaust positions. Where the housing assembly includes the aforedescribed housing and cap members, these guide surfaces preferably are in both the housing and cap members so that shifting of the valve member between its air intake and exhaust positions is in both parts of the housing assembly. In this way, the cap member can be reduced in size, particularly in the axial direction of valve member movement, as mentioned. Since the valve body is no longer utilized in the present tool, the expense associated with the manufacture of this complexly configured part is avoided. Further, the O-ring seals about the external surface valve are also avoided along with the attendant expense and maintenance thereof.

Another advantage of the present smaller cap is that the cap can be made with a lower profile in terms of the path of air flow through the cap member to the inlet air port formed therein. The cap air flow path has more of a straight across flow to the cap port when compared with the flow in the prior cap member which required air flowing across the cap to change directions for entering into an elongate generally axial passageway leading to the port located far back in the large rearwardly extending raised portion of the cap member in which the entire valve unit is disposed. Because of the lower profile of the present cap member, drastic changes in direction for air flow to the cap port as present in the prior cap member are substantially avoided. In this way, air flow paths provided by the present cap member are optimized so that cycle times for the tool are reduced. Since the air flow is more direct, it loses little momentum such as due to directional changes in the cap member, and the speed at which the piston is driven by the higher flow rate pressurized air supplied to the housing is increased.

A further benefit of the present tool construction wherein the guide surfaces are integrally formed in the housing assembly is that the passageway in the air line coupling is available for air flow therethrough for the full diameter thereof. In other words, because the valve body is no longer necessary to guide the valve member as it oscillates, the space normally taken up by the body is now available for air flow. Such increased air flow into the housing assembly reduces cycle times for the driving and return strokes of the piston.

In another aspect of the invention, the present pneumatic, hand-held power tool is provided with a light weight, robust construction for the driver head portion thereof. The head portion is provided with outer walls of a lightweight material such as magnesium and at least one bearing plate or insert of high strength material such as steel that is arranged to take and distribute the loading from the tool drive assembly across an internal bearing surface thereof. Preferably, the inserts are relatively small, elongate plates each having a flat bearing surface. The head portion includes internal pockets in which the plates are captured. Alternatively, the inserts can have a T-shaped cross-sectional configuration including an upstanding central flange and an internal cross wall or plate portion extending normal to the flange and beyond either side thereof. The internal plate portion includes the bearing surface and the flange is clamped between side plates of the head portion. Connecting pins are press-fit in apertures of the side plates and pass through clearance holes of the central upstanding flange.

Accordingly, the integrity of the preferred internal bearing plate or alternate plate portion of the T-shaped insert is not breached by through openings as in the prior tool front wall or plate that has bolts tightly received therein which creates points of stress concentration where cracking of the plate occurred with high load tool operation. Instead, in the present tool the load is distributed across the bearing surface of the solid bearing wall which avoids having localized stress concentrations such as found in prior tools at their bolting locations, as described. In the preferred plate insert, there are no fastener apertures and consequently no points of stress concentration. Further, in the alternative insert, since the locating pins are in a clearance fit in the holes of the central flange, the drive forces are not concentrated thereat. Rather, the loading is distributed across the entire extent of the internal wall bearing surface and then is transmitted to the lighter weight outer walls or side plates. Accordingly, the present head portion is both more robust in terms of the support in provides against the high driving forces of the tool and lighter in weight since most of the mass of the head portion is in the outer walls which are of light weight material versus the prior steel construction thereof.

The preferred drive assembly includes a toggle link between the piston and the driver that increases the output force thereof via the mechanical advantage generated by the camming action provided by the linkage. Even with these high forces, the present tool decreases weight at the head portion of the tool while minimizing damage to the tool head due to stresses placed thereon during high force tool operation. In this regard, unlike prior tools where all the walls were formed of heavy duty steel material as mentioned, the present tool has these outer walls primarily formed of a lightweight material to reduce the weight of the head portion with only the bearing inserts being formed of the heavier high-strength material for taking the high loads created by the camming action provided by the toggle linkage.

The material of the bearing inserts could be of similar material to that of the outer walls, however modified to be different so that it is coated with another wear resistant material or combined with another material to form a harder composite material to provide the inserts with enhanced wear resistance. Alternatively, the walls could be treated as by surface hardening thereof in the interior wall regions where the loading from the drive assembly is taken, i.e. at the top and forward internal surfaces of the tool head. In this instance, the inserts would be integral with the top and front wall portions of the tool head and their material would be different from that of the remainder tool head outer walls in the sense of its enhanced wear resistance properties at the localized bearing regions thereof.

Not only does the present tool head have a reduced weight as allowed by the provision of the high strength inserts which is desirable in and of itself for hand-held tools such as the preferred pneumatic, clip applicator tool herein, but the light weight of the head portion also enables a better balancing of the the present tool with the lighter weight of the rear cylinder assembly, as previously described. In this manner, the present tool provides an operator with improved tool ergonomics in that the tool is more lightweight than prior tools, e.g. 4 pounds, as well as also being balanced in terms of the weight distribution between the rear and forward portions thereof. Since these tools are preferably provided with a gripping portion that is located intermediate the forward and rear portions, by having the weight of the tool balanced such that the tool's center of gravity is closer to the operator's gripping portion, the operator does not need to be continually compensating for heavier rearward or forward portions of the tool as they are applying clips therewith.

### BRIEF DESCRIPTION OF THE DRAWINGS

FIG. 1 is a perspective view of a pneumatic clipping tool in accordance with the present invention having a rear cylinder assembly and a forward driver head portion with an intermediate gripping section therebetween;

FIG. 2 is a cross-sectional view of the pneumatic clipping tool of FIG. 1 showing a piston in the cylinder assembly, and a toggle link for being connected to a clip driver;

FIG. 3 is an exploded, perspective view of the tool showing one of the side plates of the tool head portion and the bearing plate inserts for the drive assembly;

FIG. 4 is an exploded view of the cylinder assembly showing a low-profile cap member, a housing member, and an air admission valve member;

FIG. 5 is a cross-sectional view of the assembled cap member and housing showing internal guide surfaces thereof for guiding shifting of the valve member with the valve member shifted to its air exhaust position;

FIG. 6 is a view similar to FIG. 5 showing the valve member shifted to its air intake position;

FIG. 7 is a partial cross-sectional view of the tool showing air flow prior to actuation of the tool with the valve member in the air exhaust position with tool including a prior tool head construction;

FIG. 8 is a view similar to FIG. 7 showing the air flow when the actuator trigger is operated to shift a control valve that governs shifting of the valve member to the air intake position thereof with the piston undergoing a driving stroke;

FIG. 9 is a view similar to FIGS. 7 and 8 showing air flow when the piston is undergoing a return stroke under the influence of a coil spring with the valve member shifted back to the air exhaust position;

FIGS. 10-12 are views of a prior clipping tool having a larger cap member that retains a valve assembly including a valve body and valve member therein and showing the air flow through the valve unit, cap member and housing in a clipping cycle thereof;

FIGS. 13-17 are various views of the low profile cap member of the present tool;

FIG. 18A is an exploded, perspective view of the head portion of the tool showing the side plates and bearing plate inserts;

FIG. 18B is a perspective view of the tool showing the head portion assembled;

FIG. 19 is a cross-sectional view of the tool head portion showing a roller of the toggle link in rolling engagement with the top bearing plate and the driver riding on the front bearing plate as the driver is extended for clenching a clip about a pair of wires;

FIG. 20 is a side elevational view of one of the side plates;

FIG. 21 is a side elevational view of the other side plate;

FIG. 22 is a front elevational view taken along line 22-22 of FIG. 21 of the side plate;

FIG. 23 is a plan view of the front bearing plate insert;

FIG. 24 is a side elevational view of the insert of FIG. 23;

FIG. 25 is a front elevational view of the FIG. 23 insert showing the T-shaped configuration thereof;

FIG. 26 is a plan view of the top bearing insert;

FIG. 27 is a front elevational view of the insert of FIG. 26 showing the T-shaped configuration thereof;

FIG. 28 is a side elevational view of the FIG. 26 insert;

FIG. 29 is a perspective view of a preferred clipping tool with one of the side plates thereof disassembled to show the preferred bearing plate inserts;

FIG. 30 is a perspective view of one of the side plates of the tool of FIG. 29;

FIG. 31 is a side elevational view of the other side plate of the tool of FIG. 29;

FIG. 32 is a front elevational view of the forward bearing plate insert;

FIG. 33 is a side elevational view of the bearing plate insert of FIG. 32;

FIG. 34 is a front elevational view of the top bearing plate insert; and

FIG. 35 is a side elevational view of the bearing plate insert of FIG. 34.

### DETAILED DESCRIPTION OF THE PREFERRED EMBODIMENTS

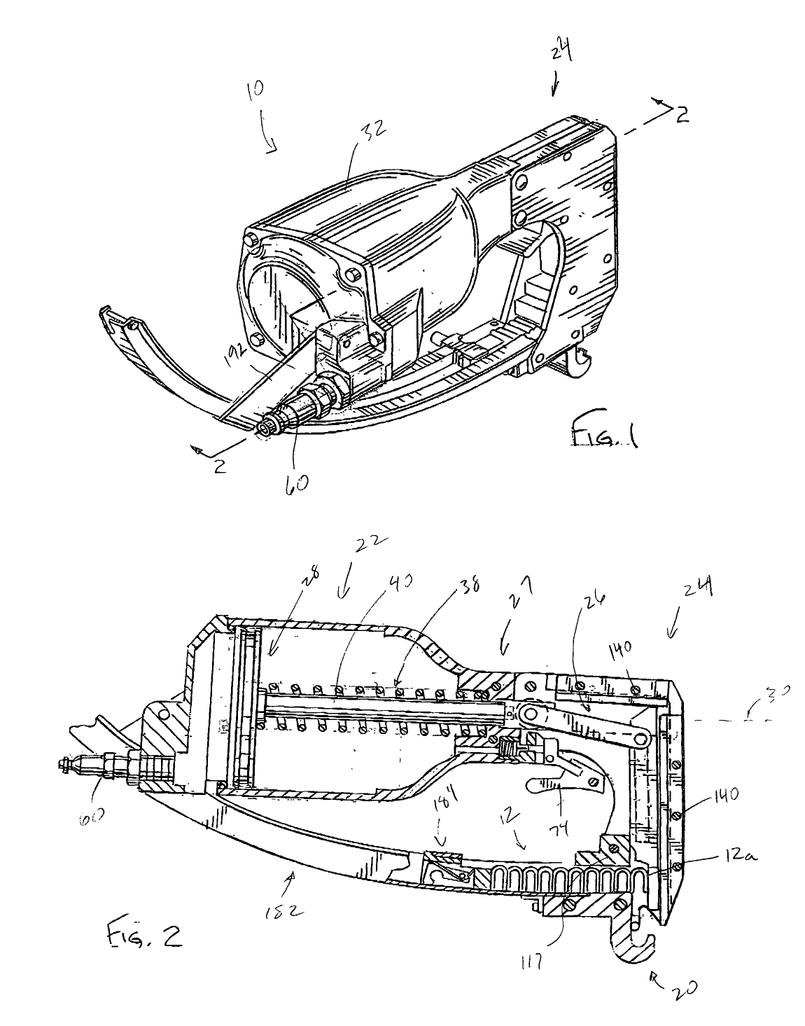

In FIGS. 1-3, a power tool 10 for driving fasteners 12 in accordance with the present invention is shown. In the preferred and illustrated form, the tool is a pneumatic clip applicator 10 for driving of U-shaped clips 12 that fasten or secure together a pair of wires 14 disposed in a clipping area 16 between a driver 18 and an anvil 20 of the applicator tool 10. The present hand-held, pneumatic clipping tool 10 is improved in many respects over prior similar tools; for instance, a reduction in parts is achieved in rear cylinder assembly 22 of the tool 10 and a reduction in weight is achieved at forward head portion 24 of the tool 10. Moreover, the weight reduction at the front head portion 24 does not sacrifice tool performance and, in fact, has been achieved while improving the robustness of the tool 10 in terms of the resistance of the head portion 24 to damage despite the high loading generated by tool drive assembly 26 including the driver 18 thereof. In addition, the ergonomics of the tool 10 can be improved as the part reduction in the rear tool portion 22 enables a weight reduction thereof which, in turn, allows for weight balancing between the reduced weight tool forward and rear portions, as will be described more fully hereinafter.

Nevertheless, it will be appreciated that the construction of either of the rear tool portion 22 or the forward tool portion 24 could be implemented in the present tool 10 independently of the other while still achieving several of the benefits as described herein. For instance, the present cylinder assembly 22 can be used in a tool including the prior head construction, as shown in FIGS. 7-9, and similarly, the present head portion 24 can be used with prior cylinder assemblies (FIGS. 10-12).

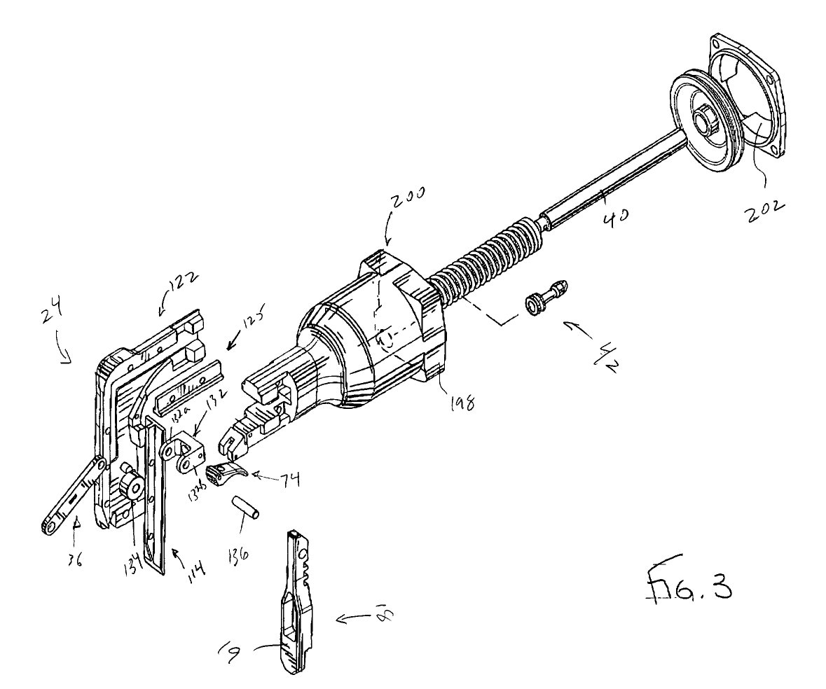

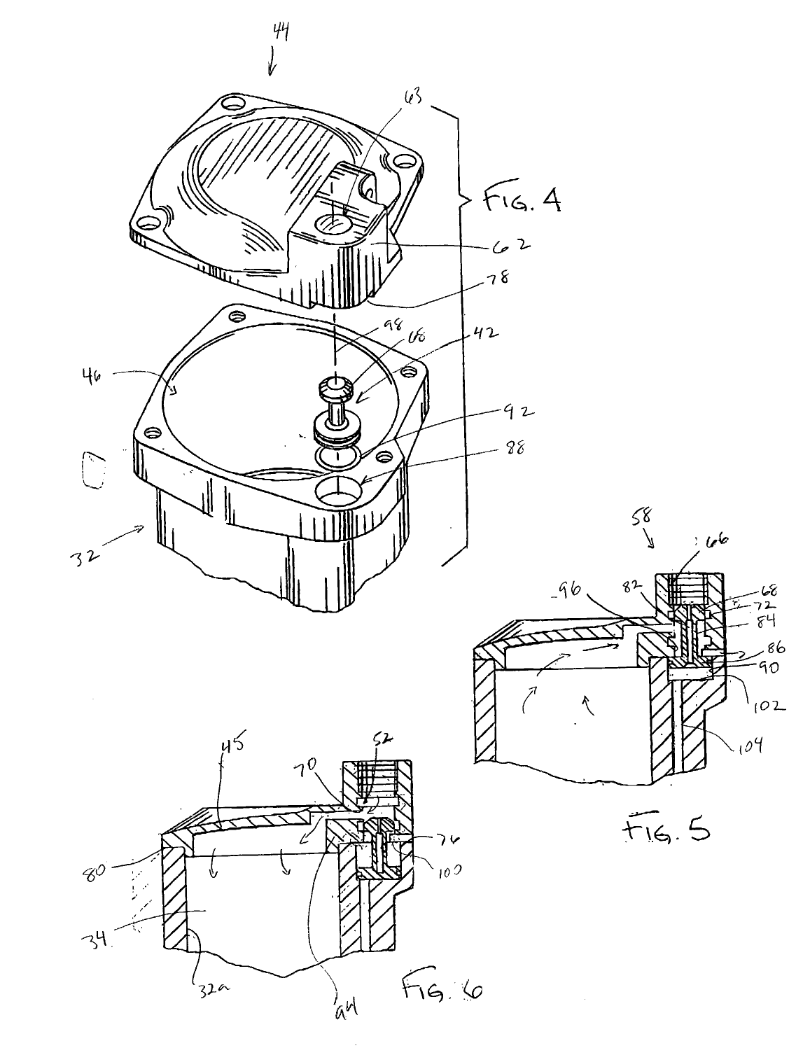

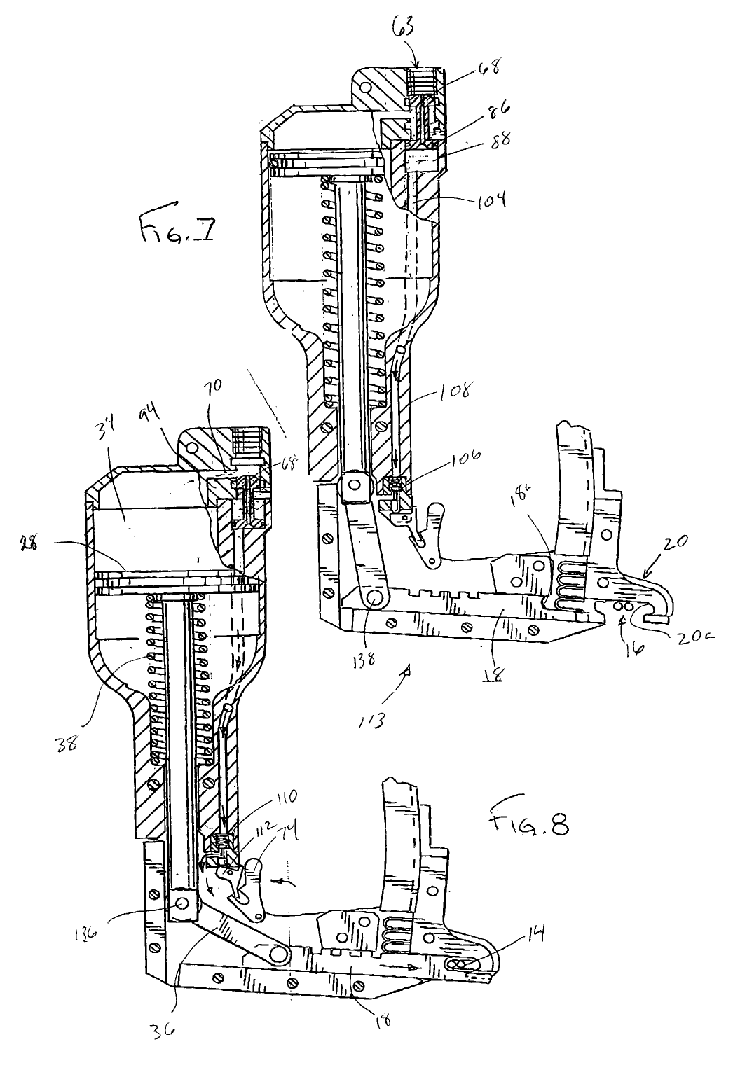

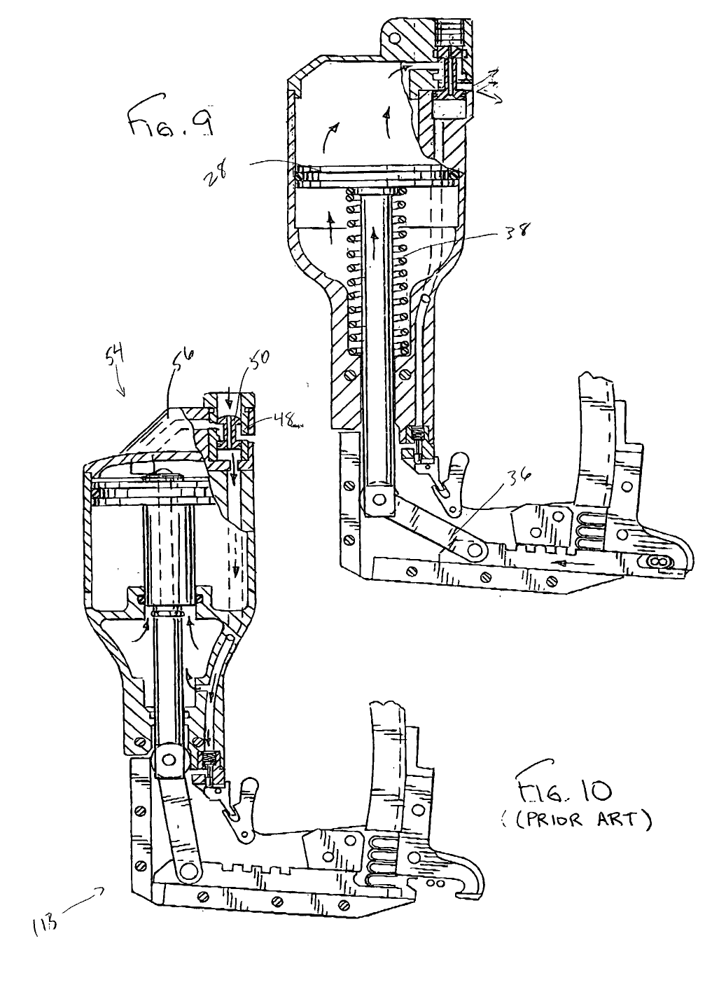

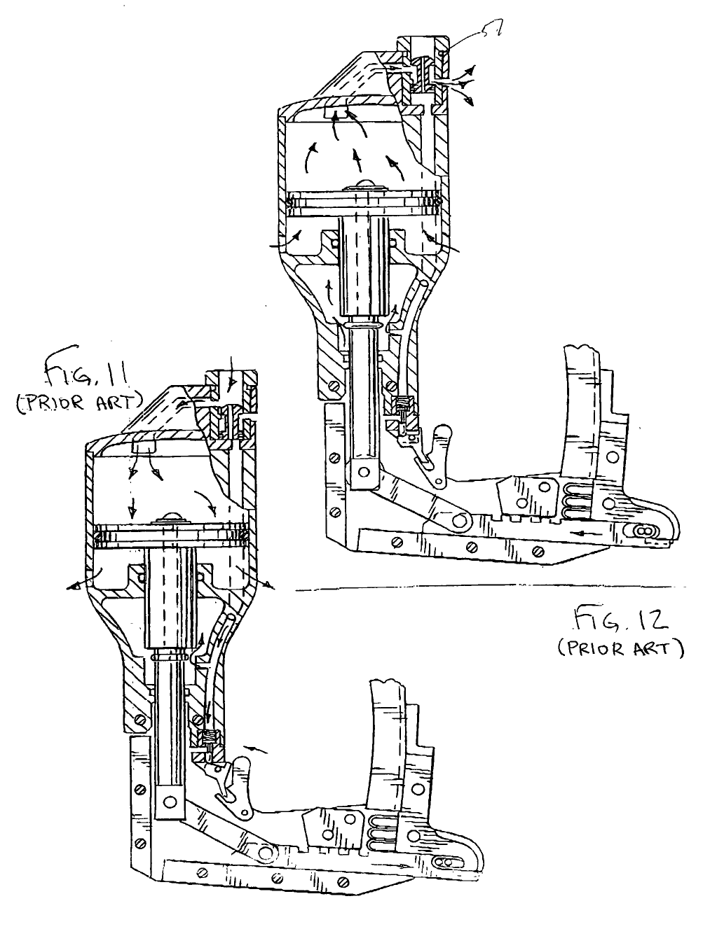

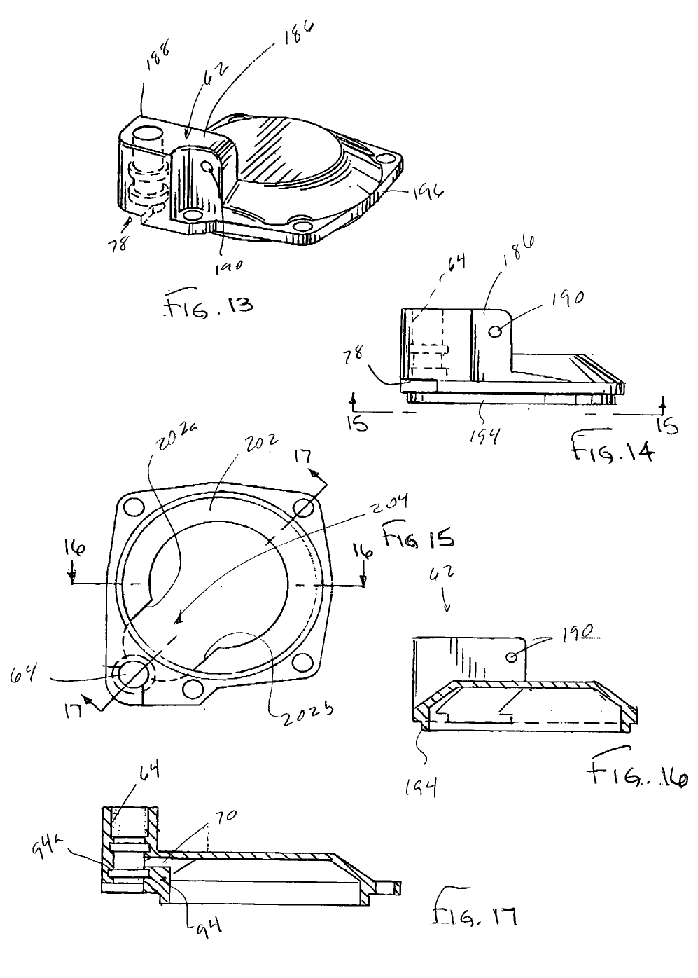

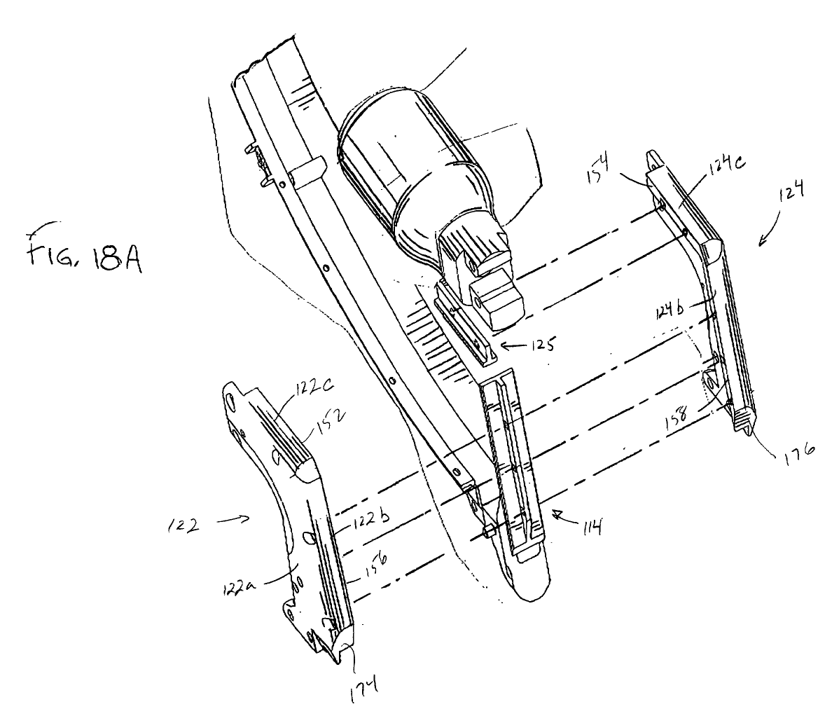

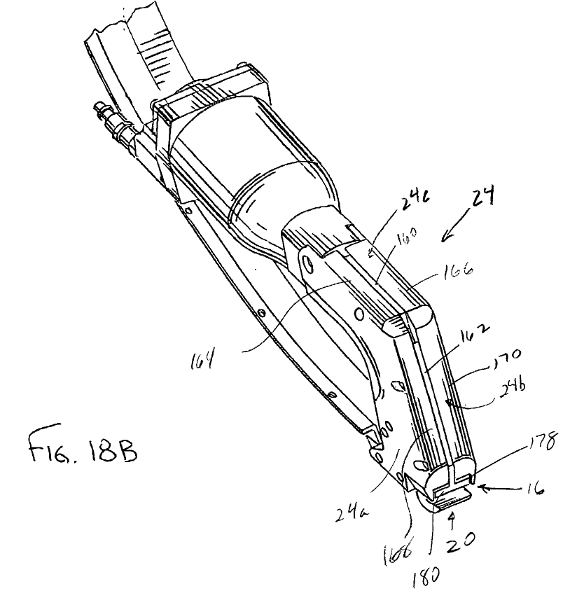

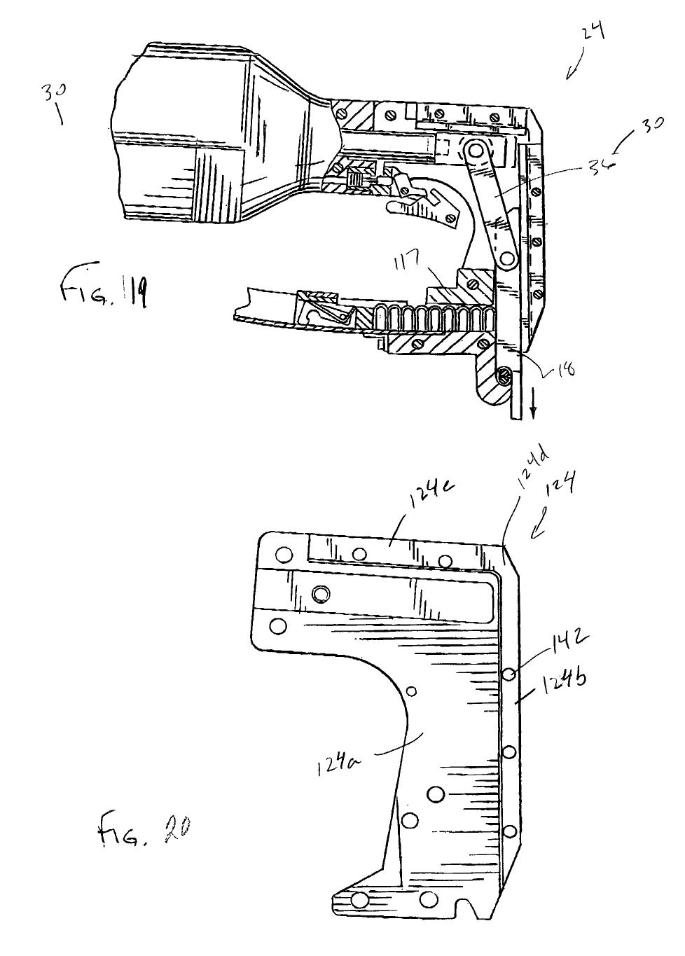

Herein, the components of the tool will generally be described with the tool 10 in the FIG. 2 orientation thereof. A tool operator will normally grip the tool 10 in intermediate gripping area 27 as between the tool rear and forward portions 22 and 24 so that tool axis 30 extends generally horizontally during clip application procedures.

The rear cylinder assembly 22 has a piston 28 that reciprocates along axis 30 in a casing or housing 32 therefor. In this regard, the piston 28 functions similar to pistons of prior tools in applying the driving force for the drive assembly 26 as by pressurized air admitted to the interior of the cylinder assembly 22, and particularly to air chamber 34 in the interior space of the housing assembly on one side of the piston 28. Accordingly, as air is admitted to the chamber 34 at the back side of the piston 28, the piston 28 is driven forwardly along the axis 30 in the housing member 32 in the drive stroke of the piston 28 pushing connected toggle link 36 forwardly which, in turn, causes the driver or plunger 18 to shift downwardly from its retracted position (FIG. 7) to its advanced position (FIG. 8) clinching a clip 12 about a pair of wires 14 arranged in the clipping area 16. Thereafter, return spring 38 coiled about piston rod 40 urges the piston 28 back toward the rear end of the housing member 32 in the return stroke of the piston 28 pulling the toggle link 36 and retracting the driver 18 back to its retracted position with the pressurized air in the chamber 34 being exhausted from the cylinder assembly 22, as shown in FIGS. 5 and 9. Although the use of pressurized air as the preferred power fluid for the present 10 tool is described, it is manifest other power fluid mediums could also be employed, e.g. hydraulics. Further, fluid passageways and porting could be provided in the cylinder assembly 22 so that the return stroke of the piston is accomplished by the power fluid instead of or in addition to the return spring 38.

To govern air flow into and out of the cylinder assembly 22, an air admission valve member 42 is provided for the housing assembly 22. In the preferred and illustrated form, the housing or cylinder assembly 22 has a two-part construction including a cap member 44 which closes off rear, open end 46 of the housing member 32 when secured thereto. Accordingly, main cover portion 45 of the cap member 44 and internal cylindrical surface 32a of the housing 32 disposed rearwardly of the piston 28 against which the piston slides cooperate to form the air expansion chamber 34 of the housing assembly 22.

In operation, the valve member 42 has an air exhaust position (FIG. 5) where air is driven out from the chamber 34 by the piston 28 undergoing its return stroke and an air intake position (FIG. 6) where pressurized air is admitted to the air chamber 34 via the cap member 44. Unlike the prior air admission valve unit shown in FIGS. 10-12 which utilizes a distinct valve body 48 in which a valve member 50 is shifted between air intake (FIG. 11) and air exhaust (FIG. 12) positions, the present tool avoids the need for the valve body 48 by integrating guide surfaces, generally designated 52, for the valve member 42 into both the cap member 44, as well as the housing member 32. In this way, shifting of the valve member 42 between its exhaust and intake positions is split between the cap member 44 and the housing member 32, unlike the shifting of the valve member 50 which occurs entirely within the larger prior cap member 54 in which the valve body 48 is received.

To this end, the prior cap member 54 has a fairly large raised portion 56 that is bored to receive the valve body 48 so that shifting of the valve member 50 between the FIG. 11 air intake position and the FIG. 12 air exhaust position occurs entirely within the cap member 54. In contrast, the present cap member 44 is provided with a much lower profile, particularly in the axial direction thereof as the cap member 44 does not need to be sized for guiding the entire extent of the axial shifting of the valve member 42 between its respective FIG. 5 air exhaust and FIG. 6 air intake positions since a part of this valve movement occurs in the housing member 32. Accordingly, splitting of valve member movement as described enables a reduction in size and thus weight of the rear cylinder assembly 22, and particularly of the cap member 44 of the tool 10. A further weight reduction of the cap member 44 can be obtained by casting it from a magnesium material which is approximately forty percent lighter than the prior aluminum material of prior cap members 54.

In addition, because the present tool 10 does away with the need for a distinct valve body such as the prior valve body 48, the valve member 42 can be formed with enlarged portions at either end thereof that are larger than that of the corresponding portions of the prior valve member 50 without a corresponding increase in size of the diameter of the bore in which the prior valve body 48 is received. The increased size of the valve member 42 herein provides faster valve response times for improved air intake and exhaust air flows translating into faster cycle times for the tool 10. Further, because the guide surfaces 52 are unobstructed by a valve body, the flow path for air traveling therethrough is larger. By taking full advantage of the entire effective diameter of these guide surfaces 52, air flow is increased, again resulting in improved cycle times for the present tool 10.

As is apparent, like the size reduction of the cap member 34, by eliminating the need for the prior valve body 48, the present tool 10 can be provided with a reduced weight rear cylinder assembly 22. In addition, the prior valve body 48 had external seals carried thereon such as O-ring 57 that are no longer needed in the tool 10 herein. As mentioned, these seals could be damaged during assembly of the valve body 48 in the prior cap member and thus the present tool 10 also avoids the tool performance and maintenance problems that this poses.

The cap member 44 has an air coupling 58 to which a source of pressurized air, e.g. 80 psi, can be connected as by high pressure air fitting 60 for an air line (not shown). The coupling 58 includes an upstanding block portion 62 that projects from the cover portion 45 of the cap member 44 such as at one corner thereof, as can be seen best in FIGS. 4, 13 and 14. The block portion 62 includes a bore 63 having an internal cylindrical surface 64 which can be provided with internal threads 66 at the upper portion thereof so that the air fitting 60 can be threaded therein. The cylindrical surface 64 extends all the way through the block portion 62 serving as the guide surface 52 for the valve member 42 in the cap member 44, and specifically enlarged end portion 68 thereof as it shifts between air exhaust and air intake positions.

A circumferentially large transverse slot opening 70 is formed in the cylindrical surface 64 to provide an internal air inlet in the cap member 44 to the air chamber 34. Between the threads 66 and the air inlet port 70, the cylindrical surface 64 can include an annular recessed groove 72 for receipt of an O-ring seal therein. This ensures that the valve portion 68 effectively seals the port 70 with the valve member 42 in the air exhaust position before and after the tool 10 drives a clip 12 as by operation of actuator or trigger 74, as will be described hereinafter.

By way of the shifting of the valve member 42 movement so that it is split between the cap member 44 and the housing member 32, the porting can also be shifted from its prior locations in the prior cap member 54. To this end, both the air inlet port 70 as well as the exhaust port 76 are shifted forwardly toward the housing member 22 and thus closer to the air chamber 34 formed between the cover portion 45 of the cap member 44 and the housing member 32. This orientation of the ports 70 and 76 improves air flow as it requires less in the way of directional changes therefor as air is admitted and exhausted to and from the cylinder assembly 22. Accordingly, with the low profile construction of the present cap member 44, the air flow for the tool 10 now has a more direct path into and out from the air chamber 34. For example, as shown, the air exhaust flow path no longer requires air to travel up and through a large raised portion of the cap and then back down through a distinct valve body as in prior tools. In particular and referencing FIGS. 10 and 12, it can be seen that in the prior tool, the provision of the large raised portion 54 for receiving the entire valve unit therein had the locations of both the inlet and outlet ports axially displaced from the corresponding air chamber. Thus, elongate air passageways need to be bored in the cap raised portion for routing the air to the valve member 50 for air travel between the inlet and outlet ports and the air chamber. In contrast, in the present tool, air flows essentially straight across the cover portion 45 between the ports 70 and 76 and the air chamber 34 for improved air flow and speed of operation of the tool 10.

Another advantage of the present cap member construction relates to the formation of the exhaust port 76. In the prior tool, the outlet or exhaust port was formed further back axially in the cap 54. Accordingly, after the cap 54 has been cast, the port has to be machined in a separate manufacturing step into the raised portion 56. In contrast, with the low profile construction of the present cap member 44, the block portion 62 can be cast with a small axial offset 78 at the bottom corner thereof, as can be best seen in FIGS. 4, 13 and 14. This axial offset 78 cooperates with the back end of the housing member 32 to form a slot opening or gap that acts as the exhaust port 76 when the cap 44 is secured to the housing member 32. In this way, the exhaust port 76 is at part line 80 between the housing member 32 and the cap member 44 thus being generally aligned with the rear end of the air chamber 34 obviating the need of significant axial runs for the exhaust air flow path between the chamber 34 and the exhaust port 76 as present with caps of the prior tools. Further, the formation of the exhaust port 76 herein does not require a separate machining step applied to the cap member 44 as with cap members of prior tools.

As previously mentioned, operation of the trigger actuator 74 shifts the air admission valve 42 between air exhaust and air intake positions. More specifically, with a high-pressure air line including fitting 60 hooked up to the tool air line coupling 58, the air admission valve member 42 will remain in a rest position, as shown in FIG. 7. As can be seen by a comparison of FIGS. 7 and 9, the rest position generally corresponds to the air exhaust position of the valve member 42. In this position, the valve end portion 68 seals off the inlet port 70 and thus high pressure air flow into the air chamber 34. The valve member 42 includes an axial opening 82 that extends through stem 84 and radially enlarged head 86 at the stem end opposite the end 68.

As previously discussed, the valve end portions 68 and 86 can now be sized larger to substantially match the size of the larger bore in which they travel, unlike the prior valve member which has corresponding end portions reduced in size to fit in the valve body which, in turn, was fit into the bore of the cap raised portion. By way of example, the valve end portion 68 can have a diameter of approximately 0.43 inch and the head portion 86 can have a diameter of approximately 0.61 inch. The prior corresponding valve portions are sized with smaller diameters of 0.37 inch and 0.48 inch, respectively.

As is apparent from above, the present valve member 42 preferably has end portions 68 and 86 of different size than each other, and in both cases larger than those of the prior valve member. To this end, the valve head 86 shifts in an annular pocket 88 of the housing member 32 including cylindrical guide surface 90 against which the periphery of the valve head 86 including O-ring seal 92 carried therewith rides. Adjacent the annular pocket 88, there is a short annular wall section 94 of the cap member 44 which includes a cylindrical surface portion 96 of internal block surface 64 that acts to guide the valve end portion 68 for shifting of the valve member 42 in the cap member 44. Accordingly, the cylindrical surface portion 96 is of the same diameter as the cylindrical surface 64, which are both smaller in diameter than the larger diameter housing cylindrical surface 90 that guides the radially larger valve head 86.

The cap member 44 is preferably of a one-piece, unitary construction such that the block portion 62 including the annular wall section 94 thereof are integrally formed therewith. In a like manner, the main housing member 32 is preferably of a one-piece, unitary construction such that the pocket 88 is integrally formed therewith. In this manner, the guide surfaces 52 for the valve member 42 are integrated into both the cap member 44 and housing member 32 via respective integral surfaces 64 and 90 thereof for guiding the shifting of the valve member 42, and particularly valve member end portions 68 and 86.

As can be seen best in FIGS. 5 and 6, since bore 63 is aligned with pocket 88 along central axis 98, the wall section 94 overhangs the pocket 98 forming rear shoulder 100 extending thereabout. The shoulder 100 serves to limit rearward travel of the valve member 42 as it is shifted to the rest or air exhaust position, whereas transverse forward surface 102 of the pocket 88 serves to limit the forward shifting of the valve member 42 to the air intake positions thereof.

The wall section 94 extends axially for only a very short distance that is sufficient for annular groove 94a that carries an O-ring seal to be formed therein. As such, the air inlet port 70 is formed only slightly axially rearward of the part line 80. Accordingly, the long, narrow passageways into which air flow is rerouted in the prior cap member 54, and specifically into large raised portion 56 thereof are avoided by the present low profile cap member 44 which provides generally unimpeded air flow across the cover portion 45 thereof and back up and around the annular wall section 94 to the port 70 and into bore 63. No long runs of air flow through small diameter passageways that change directions are required for intake and exhaust air flows in the present tool 10 thus reducing tool cycle times, as previously discussed. It has been found that the various air flow improvements incorporated into present tool 10 have improved its speed of operation so that it is approximately twice as fast as the prior clipping tools.

The axial through opening 82 in the valve member 42 allows high-pressure air from the cap bore 63 to bleed into the housing pocket 88. An elongate air passageway 104 communicates with the pocket 88 and extends forwardly along the housing member 32 down to a forward end thereof at which control valve 106 is disposed. As shown, the housing 32 includes a forward neck down section 108 which forms at least a portion of the tool gripping area 27 and includes a small pocket 110 at the forward end thereof in communication with the passageway 104. The control valve 106 is disposed in the pocket 110 and biased so that it is normally in the closed position thereof. Accordingly, passageway 104 is sealed and the air pressure built-up therein will act to shift the main valve member 42 rearwardly to the rest position thereof, as shown in FIG. 7. The valve member 42 shifts rearwardly because of the greater rearward force placed thereon due to the larger surface area of the larger valve head 86 in the pocket 88 versus the smaller valve end 68 in the cap bore 63. In the rest position, the valve head 86 abuts against the shoulder 100 formed by the cap wall section 94, as previously described, with the valve end 68 rearward of the inlet port 70 sealing it from the pressurized air in the bore 63.

For driving a clip 12, the operator pulls trigger actuator 74 which shifts pivot member 112 for pushing the control valve 106 against its bias rearwardly to the open position thereof, as shown in FIG. 8. With the control valve 106 open, air in the passageway 104 is exhausted therefrom such that the main valve 42 now shifts to its air intake position as a result of the pressurized air in the bore 63, as can be seen in FIG. 8. In this position, the main valve member 42 is shifted forwardly with the valve head 86 bottomed out against the forward surface 102 of the housing pocket 88. The valve end portion 68 is shifted forwardly past the inlet port 70 to allow pressurized air to flow therethrough and into the air expansion chamber 34.

As previously described, the intake of pressurized air in the chamber 34 causes the piston 28 to move forwardly against the bias provided by return spring 38, pushing the toggle link 34 which, in turn, causes the driver 18 to be advanced to its extended position. In this advanced position, the driver 18 cooperates with the anvil 20 to tightly wrap or clinch a clip 12 about a pair of wires 14. The wedging or camming driving action created by the toggle linkage between the piston rod 40 and the driver 18 increases the output force of the tool as applied to the clips 12. In practice, the present drive assembly 26 is effective to generate approximately twenty-five hundred pounds of output force with the piston 28 driving the toggle link 36 and attached driver 18 with nine-hundred pounds of force. Release of the trigger 74 allows the control valve 106 to return to its closed position with the build-up in air pressure in the passageway 104 shifting the main valve member 42 back to its air exhaust position to seal the chamber 34 from further intake of pressurized air and to open the exhaust port 76 to the chamber 34. This allows the piston 28 to shift in its return stroke back rearwardly under the influence of spring 38 to force air out of the cylinder assembly 22 via the open exhaust port 76, as shown in FIG. 9.

Referring next to FIGS. 18A and 18B, one form of tool head portion 24 is illustrated which, as has been mentioned, is improved both in its ability to resist the high-loading placed thereon by the drive assembly 26 and in lowering its weight relative to the steel plate construction of prior tool head portion 113, shown in FIGS. 7-12. More particularly, the tool head portion 24 has a high strength bearing insert or plate 114 having a large, flat bearing surface 116 against which forward flat surface 19 of the clip driver 18 rides as it is shifted between retracted and extended positions thereof. A guide block 117 attached toward the bottom in the interior of the tool head 24 cooperates with the bearing surface 116 to capture the driver 18 therebetween and guide it for sliding movements thereagainst during its advance and retract strokes.

The insert 114 has a T-shaped configuration in cross-section, as best seen in FIG. 25. In this regard, the insert 114 has a central flange 118 and an internal cross wall or plate portion 120 extending beyond either side of flange 118 and on which bearing surface 116 is formed. As shown, the upstanding flange 118 preferably extends normal to the flange wall 120 to form the T-shaped configuration thereof so that the insert has an increased moment of inertia to provide it with increased strength and rigidity.

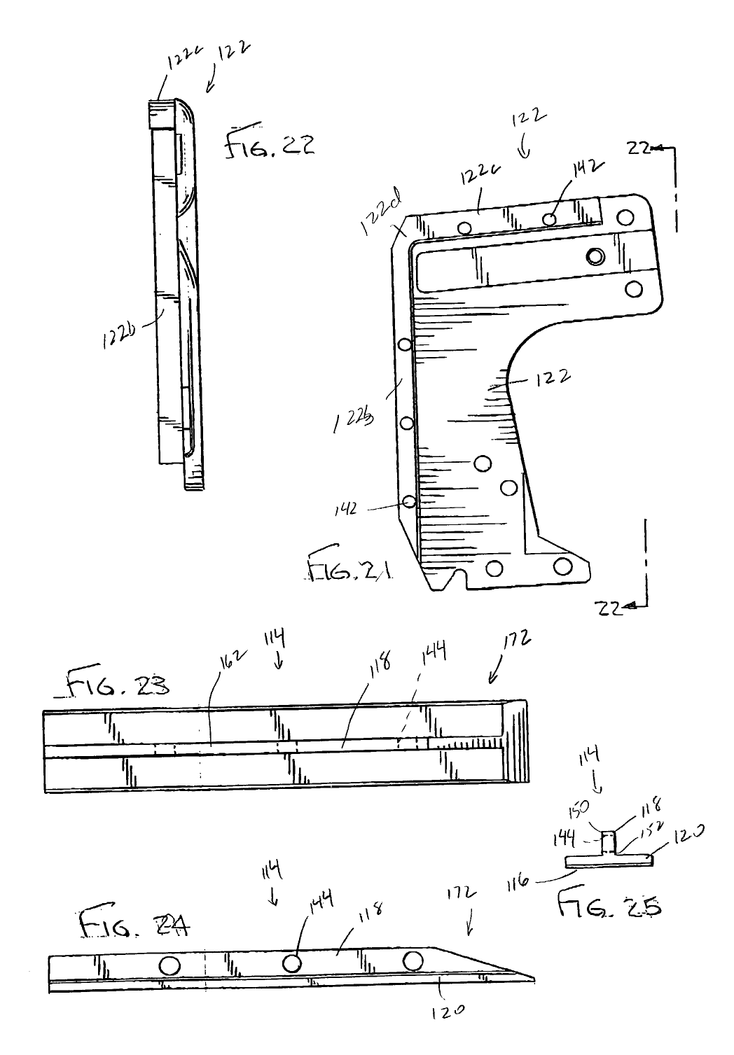

The head portion 24 herein includes a pair of light weight side plates 122 and 124 of substantially mirror-image construction. When connected as by bolting, the side plates 122 and 124 cooperate to form the outer walls including opposite side walls 24a, front wall 24b, and top wall 24c of the tool head portion 24, as can be seen in FIGS. 18A and 18B. More specifically, each side plate 122 and 124 includes respective side portions 122a and 124a that form the outer side walls 24a of the head portion 24. Further, the side plates 122 and 124 are preferably integrally cast with arcuate flanges 122b and 124b extending along the forward end thereof and arcuate flanges 122c and 124c extending along the upper end thereof, as can be seen in FIGS. 20-22. Thus, with the side plates 122 and 124 connected, the flange portions 122b and 124b cooperate to form the front wall 24b of the tool head portion 24 with the insert flange 118 clamped therebetween.

As the side plates 122 and 124 are preferably each integrally formed, the forward flanges 122b, 124b and upper flanges 122c, 124c have integral corner portions 122d, 124d at their junctures. In this manner, the upper, forward corner of the tool head portion 24 is more robust as separate pieces, such as in the form of the top and front plates of the prior tool of FIGS. 10-12, that form a part line at the corner are avoided. Instead, the integral side plates 122 and 124 have their forward and upper flanges or wall portions 122b, 124b and 122c, 124c, respectively, integrally connected and tied together via the corner wall portions 122d, 124d for load bearing purposes.

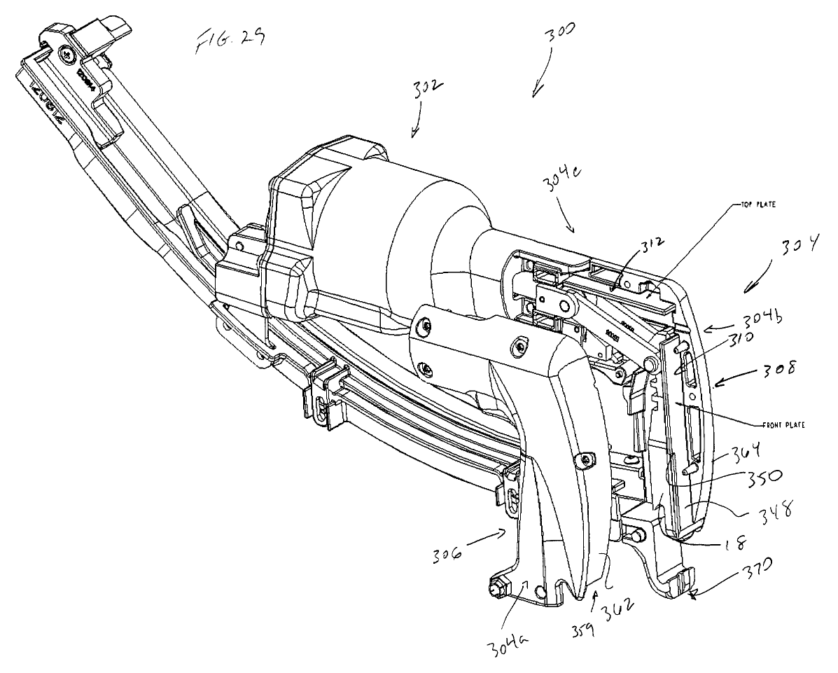

Referencing FIGS. 26-28, a top bearing insert 125 can be provided for load bearing reasons as will be described more fully herein. The insert 125 also can have a T-shaped cross-sectional configuration for strength purposes similar to that of forward bearing insert 114. Accordingly, the insert 125 includes an upstanding, central flange portion 126 and a cross plate portion 128 extending generally normal thereto and on which a flat bearing surface 130 is formed. Like the insert 114, the flange 126 of insert 125 is clamped between the arcuate, upper flange portions 122c and 124c when the side plates 122 and 124 are secured together. In this way, it is the flange portions 122c and 124c along with the insert flange 126 clamped therebetween that cooperate to form the upper wall of the tool head portion 24.

As the insert 114 is in flush engagement with the driver 18, it is larger than the insert 125. The driven piston 28 along with its piston rod 40 extending along tool axis 30 is driven forwardly in the drive stroke thereof during clip-clenching operations. Referring to FIG. 3, a yoke member 132 is connected at the forward end of the piston rod 30 for rotatably mounting a roller 134 between bracket arms 132a and 132b of the yoke 132 via pin 136 received in aligned apertures formed therein. The pin 136 extends beyond the bracket arms 132a and 132b to pivotally mount a pair of toggle links 36, one of which is shown in FIG. 3. At their other ends, the toggle links 36 are pivotally mounted to the upper end of the driver 18 via pin 138. Accordingly, the toggle links 36 pivotally connect the piston rod 40 to the clip driver 18 which extend in transverse directions, and more specifically, substantially perpendicular to each other. The top insert 125 and bearing surface 130 thereof extend in the fore and aft direction along the tool axis 30 similar to the piston rod 40 such that the roller 134 connected at the forward end of the rod 40 rides thereon.

Through its provision of wear inserts 114 and 125 and light weight side plates 122 and 124, the tool head 24 employs more robust, wear resistant material in those areas wear such properties are needed most with the remainder of the head 24 being of a different and lighter weight material. Since wear resistant material is primarily needed along the travel paths of the roller 134 and the driver 18, this generally harder and/or heavier wear resistant material can be employed in a generally small, internal area of the head 24. Accordingly, the inserts can be provided with a fairly small size. For example, the forward insert bearing surface 116 can have a width of approximately 1 inch and a length of approximately 5 inches, and the top insert bearing surface 130 can have a width of approximately ⅜ inch and a length of approximately 2 ½ inches.

In both cases, the inserts 114 and 125 are preferably made of high-strength material such as steel to provide a robust support for the drive assembly 26 against the high forces generated thereby during clipping operations. At the same time, the inserts 114 and 125 are constructed and assembled so as to allow the side plates 122 and 124 to be of a lighter weight material such as cast from magnesium, so as to reduce the weight of the head portion 24 without sacrificing its performance in terms of resistance to stress damage. Alternative plate materials can include aluminum and even molded plastic. In fact, the tool head portion 24 of the present tool 10 is more robust than the steel plate construction of the prior tool head portion 113 as the loading is not concentrated at the bolt locations, and instead is distributed across the bearing surfaces 116 and 130 before being transmitted to the light-weight side plates 122 and 124. By avoiding stress concentrations, the high drive forces are dissipated before they are transmitted to the light-weight side plates 122 and 124 avoiding damage thereto.

More specifically, the inserts 114 and 125 are clamped between the side plates 122 and 124 and are accurately positioned relative thereto by several locating pins 140 (FIG. 2). The plates 122 and 124 are provided with a corresponding number of apertures 142 along their forward flange portions 122b, 124b, and upper flange portions 122c, 124c, which are sized to receive the pins 140 as by a press fit therein. In contrast, the respective insert flanges 118 and 126 are provided with through apertures 144 that are sized to be in a clearance or location fit with the pins 140. As such, the pins 140 do not create load bearing locations for the tool head portion 24 as they do not transmit loads taken by the inserts 114 and 125 to the side plates 122 and 124. Accordingly, drive forces are borne by the inserts 114 and 124 and distributed across the full extent of the respective bearing surfaces 116 and 130 thereof prior to being transferred to the plates 122 and 124. In this manner, rather than having heavily localized loading at bolting locations in the outer walls, the construction of the light weight tool head portion 24 dissipates drive forces before transmitting them to the tool head outer walls 24a-24c as formed by the secured together side plates 122 and 124.

As shown in FIG. 18A, the plate apertures 142 and the insert apertures 144 are aligned with each other for receipt of the pins 140. More particularly, the flange 126 of the illustrated top insert 125 has a pair of through apertures 144, and the side plate upper arcuate flanges 122c and 124c each have a pair of apertures 142 aligned therewith. Similarly, the illustrated forward insert 114 has three through apertures 144 in the flange 118 thereof, and the side plate forward flanges 122b and 124b each have three apertures 142 aligned therewith. The apertures 144 of the upper insert 125 extend through to either opposite, outward facing surface 146 and 148 of the flange 126. Likewise, the apertures 144 of the forward insert 114 extend through to opposite, outward facing surfaces 150 and 152 of the flange 118. The apertures 142 of the side plate upper flanges 122c and 124c are formed in respective inward facing surfaces 152 and 154 thereof, and the apertures 142 of the side plate forward flanges 122b and 124b are formed in respective inward facing surfaces 156 and 158 thereof.

With the head portion 124 assembled, the side plate flange surfaces 152-158 are clamped against corresponding flange surfaces 146-150 so that the apertures 142 and 144 are aligned, as described above. The insert flanges 118 and 126 are sized and the through apertures 144 thereof are positioned relative to the side plate flanges 122b, 124b and 122c, 124c and their apertures 142 such that with the side plates 122 and 124 secured together via the pins 140 press fit in apertures 142 and extending through the apertures 144, respective end surfaces 160 and 162 of the insert flanges 114 and 125 interconnecting the opposite flange faces 146, 148 and 150, 152 will be flush with the outer surface of the side plates 122 and 124. More specifically, outer surface portions 164 and 166 of the side plate upper flanges 122c and 124c, respectively, are flush with the flange end surface 160, and outer surface portions 168 and 170 of the side plate forward flanges 122b and 124b, respectively, are flush with the insert flange end surface 162, as shown in FIG. 18B.

By way of the above-described T-shaped construction for the inserts 114 and 125 where the upstanding flanges 118 and 126 thereof are apertured, the bearing cross-plate portions 120 and 128 can remain solid to provide them with increased strength for load bearing purposes. Unlike prior top and forward plates that had through apertures extending through the widthwise dimension thereof, the present insert plate portions 120 and 128 including the respective load bearing surfaces 116 and 130 thereof remain solid with only the clamping flanges 118 and 126 being apertured, and then, only through the thickness thereof which can be, for example, on the order of approximately 0.125 inch.

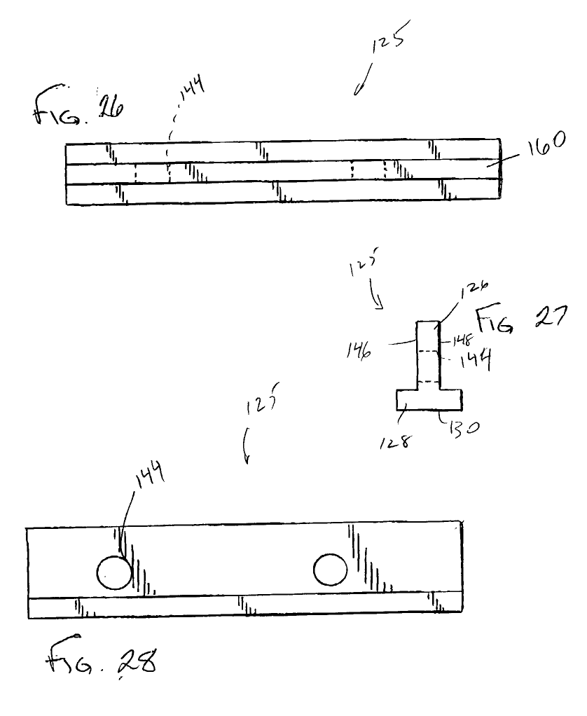

Referring to FIGS. 23 and 24, it can be seen that the insert 114 tapers at end 172 thereof. As assembled in the tool head portion 24, the insert end 172 is at the lower, forward end of the tool 10 where the clipping area 116 between it and the anvil 20 is formed, as can be seen in FIG. 18B. The insert flange 118 tapers rearwardly toward the cross-plate portion 120 with the corresponding end of the plate portion 120 being similarly tapered to present a continuous smooth taper at the insert end 172, as best seen in FIG. 24. The side plates 122 and 124 include a tapered area 174 and 176 at their respective forward, lower end substantially corresponding in their taper to that of the insert end 172 to be flush therewith, as shown in FIG. 18B.

Continuing reference to FIG. 18B, the tapered areas 174 and 176 of the side plates 122 and 124 are configured to cooperate to form a generally rectangular setback 178 in which endmost portion 180 of the tapered end 172 of the insert 114 is disposed. As can be seen, by having the insert end portion 180 extend beyond the side plates 122 and 124 in setback area 178, the present head portion 24 has the high strength load bearing material of the insert 114 positioned very close to the anvil 20 in the clipping area 16. In this manner, the enhanced load bearing ability of the present insert and side plate arrangement as described above is obtained for the majority of the length of travel of the driver 18 as it is driven to its extended position. In addition, because very high forces are generated in the clipping area 16, the recessing or setting back of the area 178 in the light weight side plates 122 and 124 is advantageous in avoiding damage thereto that otherwise could create problems for the driver 18 in the return stroke thereof.

Turning to more of the details, the tool 10 has an elongate, arcuate clip magazine 182 that extends past the rear end of the tool 10 to adjacent the forward end at the tool clipping area 16, as can be seen in FIGS. 1 and 2. The magazine 182 is sized to hold a strip of collated clips 12 feeding a single leading one of the clips 12a out from the forward discharge end thereof into alignment with the driver 18. As the driver 18 is extended, it will shear the leading clip 12a off from the remainder of the clips 12 in the collated strip and advance it into the clipping area 16. Curved end 18a of the driver 18 cooperates with curved surface 20a of the anvil 20 to guide the prong legs of the clip 12 to wrap tightly around the wires 14, as is known. A pusher mechanism 184 biases the strip of clips 12 forwardly in the magazine 182 so that once the driver 18 is retracted back up into the tool head portion 24, the leading clip 12a of the strip is cleared for advancing it into position for being driven to be clinched about the wires 14 in the clipping area 16.

To keep the magazine 182 rigidly secured to the portable tool 10, the cap member 44, and particularly the block portion 62 thereof is provided with a thin mounting section 186 that projects along one side of the cap member 44 away from the main valve section 188 of the cap block portion 62, as best seen in FIG. 13. The thinned section 186 includes a through hole 190 to allow mounting arm 192 connected at one end to the magazine 182 to be secured to the cap member 44 as by a fastener.

Referring more specifically to FIGS. 13-17, the cap member 44 has a skirt wall 194 that fits snugly in the open rear end 46 of the housing member 32 with perimeter surface 196 of the cap member 44 configured and sized similar to perimeter surface 198 of the rear housing portion 200 (FIG. 3). In this manner, when the cap member 44 is secured to the housing member 32 as by bolting, the perimeter surfaces 196 and 198 will generally be flush with one another. Rearwardly of the skirt wall 194 and radially inward therefrom is a generally annular inclined wall 202 that extends about the interior of the cap member 44, as best seen in FIGS. 3 and 15. Annular wall 202 terminates at spaced ends 202a and 202b on either side of the bore 64 formed in the cap block portion 62. Accordingly, the wall 202 defines a large space 204 for air flow between the bore 64 and the air chamber 34 formed by the assembled housing 32 and cap 44. As is apparent, this large spacing allows for substantially unimpeded air flow through the cap member 44 unlike the elongate, narrow passageways in prior cap members 54, as previously described.

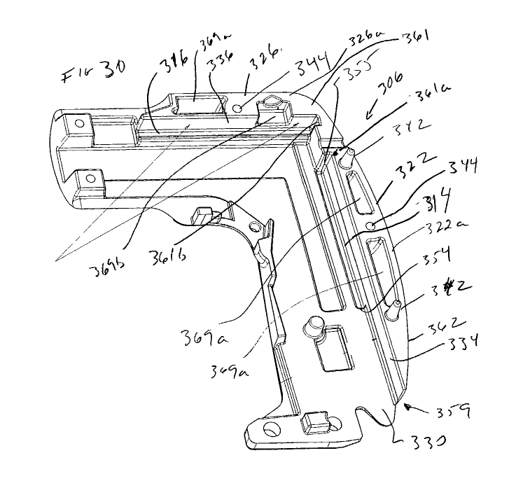

The preferred tool 300 in accordance with the present invention will next be described. Referring the FIG. 29, the applicator tool 300 is similar to tool 10 in the construction of the rear cylinder assembly 302 thereof. The forward head portion 304 is modified from head portion 24 in the construction of its side plates 306 and 308 and bearing inserts 310 and 312, as described hereinafter. The primary difference between the side plates 306 and 308 and inserts 310 and 312 compared to side plates 122 and 124 and inserts 114 and 125 is that the inserts 310 and 312 are of a flat plate construction, and the plates 306 and 308 position and hold the inserts 310 and 312 via internal pockets formed therein.

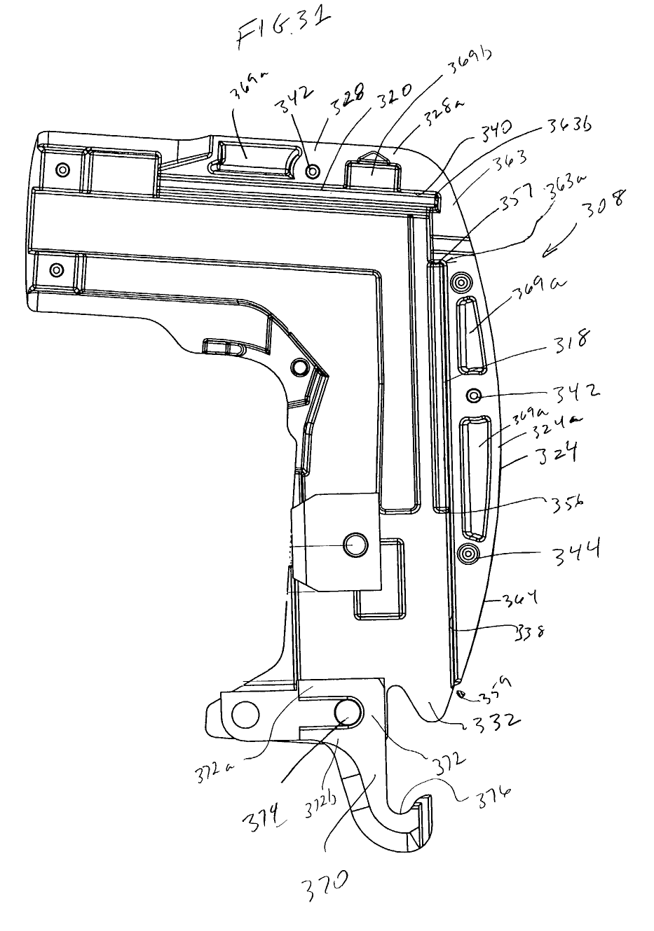

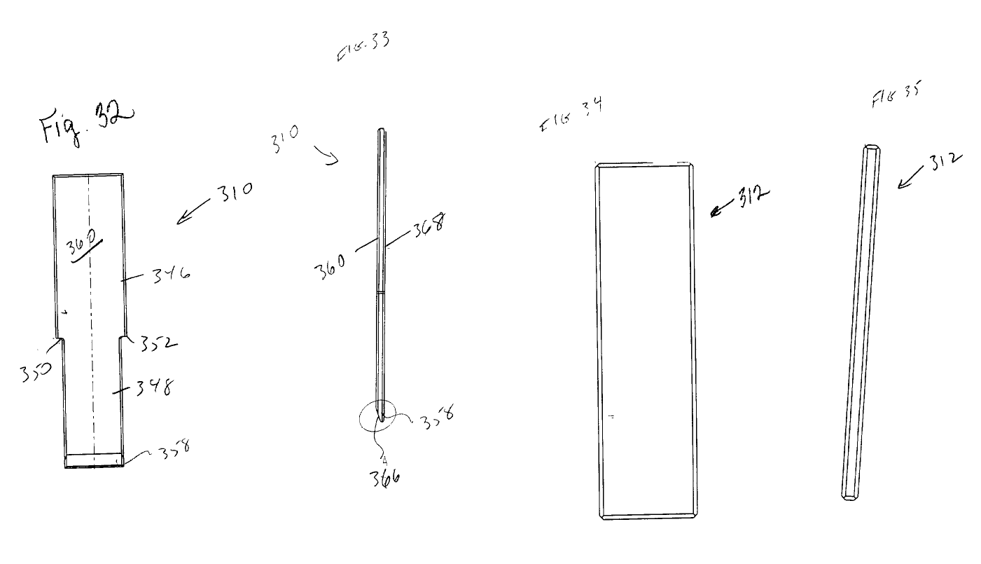

More specifically and referencing FIGS. 30 and 31, it can be seen that the plates 306 and 308 each have a pair of elongate channels or recesses 314, 316 and 318, 320, respectively. The internal recesses 314 and 316 of plate 306 and the internal recesses 318 and 320 of plate 308 extend transverse to each other, and preferable normal to each other with recesses 314 and 318 extending vertically in the forward region of the tool head portion 304, and the recesses 316 and 320 extending horizontally in the upper region of the tool head portion 304. The recesses 314 and 318, and the recesses 316 and 320 cooperate to form the internal pockets that capture the respective plate inserts, 310 and 312 therein when the plates 306 and 308 are assembled as by bolting.

As shown, each of the plates 306 and 308 include a forward raised block wall portion 322 and 324 adjacent to and forwardly of respective recesses 314 and 318, and upper raised block wall portions 326 and 328 adjacent to and above upper recesses 316 and 320. The forward wall portions 322 and 324 are raised to project toward each other as are the upper wall portions 326 and 328 from their respective side plates 306 and 308. These wall portions 322-328 cooperate with the recesses 314-320 to securely hold the bearing plates 310 and 312 in place when the tool head portion 304 is assembled.

More particularly, the side plates 306 and 308 each have a main internal surface 330 and 332 from which the recesses 314, 316 and 318, 320 are formed, respectively. Similarly, the wall portions 322 and 326 are raised from the surface 330 of the plate 306, and the wall portions 324 and 328 are raised from the surface 332 of plate 308. The recesses 314-320 have a generally narrow rectangular slot configuration with a length and a width or depth thereof sized for fitting a portion of the generally rectangularly configured thin plate inserts 310 and 312 therein. The forward wall portion 322 has a rear, flat internal surface 334 that extends continuously with the forward, flat surface of the recess 314 which extends along the length thereof, and the upper wall portion 326 has a bottom, flat internal surface 336 extending continuously with the top, flat surface of the recess 316 which extends along the length thereof. Similarly, the forward wall portion 324 includes a rear, flat internal surface 338 that extends continuously with the front surface of recess 318 which extends along the length thereof, and the upper wall portion 328 includes a bottom, flat surface 340 that extends continuously with the upper surface of the recess 320 which extends along the length thereof. When the plates 306 and 308 are attached together, the recesses 314 and 318 are in facing relation with the surfaces 334 and 338 aligned, and the recesses 316 and 320 are in facing relation with the surfaces 336 and 340 aligned. The plate inserts 310 and 312 are backed and supported in substantial flush engagement against the internal surfaces 334-340 with the plates 310 and 312 residing in the respective pockets formed by the recesses 314-320.

In this manner, the preferred plate inserts 310 and 312 can forego the T-shaped construction of the previously-described inserts 114 and 125 including their apertured central flanges for size and weight-reduction purposes, as well as simplifying their manufacture. As such, the outer walls including sidewalls 304a, front wall 304b and top wall 304c of the tool head portion 304 are formed entirely by the assembled side plates 306 and 308. To locate the plates 306 and 308 properly aligned relative to each other as described, the plates 306 and 308 are provided with integral locating bosses including tapered pin portions 342 and corresponding aligned tapered apertures 344 in which the pin portions 342 are received, as shown formed at the block portions 322-328. With the pins 342 tightly received in the apertures 344, the forward wall portions 322 and 324 will abut each other along respective surfaces 322a and 324a thereof to cooperate to form the tool head front wall 304b. Similarly, the upper wall portions 326 and 328 will abut each other along respective surfaces 326a and 328a thereof to cooperate to form the tool head top wall 304c.

For fitting the plate inserts 310 and 312 into the respective forward and upper pockets therefor, the plates 310 and 312 can be slightly larger in width than the corresponding plate portions 116 and 128 of inserts 114 and 125. Referring to FIG. 32, it can be seen that the plate insert 310 has an upper, wider section 346 for fitting into the forward pocket, and specifically the forward vertical internal recesses 314 and 318. A lower, narrower section 348 of the plate insert 310 depends centrally from the upper section 346 forming shoulders 350 and 352 on either side of the juncture between the plate sections 346 and 348.

The forward recesses 314 and 318 which form the forward pocket for the insert 310 include lower abutment surfaces 354 and 356, respectively. The surfaces 354 and 356 extend transverse and preferably perpendicular to the lengthwise extending surfaces 334 and 338, respectively. Accordingly, the recesses 314 and 318 terminate at their lower ends at these widthwise extending end surfaces 354 and 356. The surfaces 354 and 356 are spaced above the lower end of the respective forward wall portions 322 and 324 at a distance which corresponds to slightly less than the length of the narrow section 348 of the forward insert 310, as will be described more fully hereinafter. Further, the length of the recesses 314 and 318 are approximately the same or slightly greater than the length of the upper section 346 of the insert 310. To this end, the recesses 314 and 318 are provided with upper end surfaces 355 and 357 positioned so that the spacing to the lower surfaces 354 and 356 generally corresponds to the length of plate section 346.

The side plates 306 and 308 each include respective integral corner portions 361 and 363. The corner portions 361 and 363 are raised from the plate surfaces 330 and 332 and interconnect the raised front and upper wall portions 322, 326 and 324, 328 of the plates 306 and 308, respectively. The corner wall portion 361 includes an internal surface 361a that is aligned with recess end surface 355, and the corner wall portion 363 includes an internal surface 363a that is aligned with recess end surface 357. With this arrangement, the insert section 346 seats snugly in the recesses 314 and 318 forming the forward pocket with the shoulders 350 and 352 engaged against the respective abutment walls 354 and 356 and the upper end of the insert 310 in close facing relation to the recess end surfaces 355 and 357 and aligned wall surfaces 361a and 363a.

As mentioned, the lower insert section 348 is sized to be slightly longer than the spacing of the bottom end of the recesses 314 and 318 from a bottom cut-out 359 formed at the lower, forward nose end of the plates 304 and 308. Accordingly, with the insert section 346 captured in the forward pocket, the lower section 348 continues downward external of the forward pocket recesses 314 and 318 with end portion 358 thereof projecting beyond the set back 359 formed at the bottom of the forward wall portions 322 and 324, as can be seen in FIG. 29, in a manner akin to the previously described insert end portion 180 (see FIG. 18B).

For substantially the entire length of the insert 310 including the sections 346 and 348 less the tapered end portion 358, the insert flat forward surface 360 bears flush against the rear surface 334 of the wall portions 322 and 324 extending into the corresponding recesses 314 and 318 as the forwardmost lengthwise surface thereof, as previously described. The tapered end 358 can be angled to correspond to the contour of the front surface 362 and 364 provided on the wall portions 322 and 324, respectively. As shown, the tapered portion 358 includes tapered surface 366 that forms an angle of approximately 20 degrees with the front surface 360 and flat rear surface 368 thereof with the front wall surfaces 362 and 364 each having a curvature to present smooth transition between the exposed tapered surface 366 in the lower cut-out 359 and the front wall 304b of the tool head 304.

As mentioned, the plate inserts 310 and 312 can be slightly wider than the corresponding plate portions 116 and 128 of the prior T-shaped inserts 114 and 125 for seating in the pockets therefor. Accordingly, by way of example and not limitation, the wider section 346 of the insert 310 can have a width of approximately 1 inch and a length of approximately 2.5 inches, with the lower narrower section having a width of approximately 0.9 inch and a length of approximately 2 inches, for a total length of the insert 310 of approximately 4.5 inches. Referring to FIGS. 34 and 35, the top insert plate 312 has a generally rectangular configuration, and can have a width of approximately ¾ inch and a length of approximately 2¾ inches. In each instance, the inserts 310 and 312 can have a thickness of approximately ⅛ inch similar to the plate portions 116 and 128 of the previously described inserts 114 and 125.

With respect to the upper insert 312, it seats in the upper pocket so that its upper flat surface 312a bears against the lower surfaces 336 and 340 of the respective upper wall portions 326 and 328 which extend into the recesses 316 and 320 as the upper surfaces thereof. The corner portions 361 and 363 include internal surfaces 361b and 363b that extend into the recesses 316 and 320 to form the widthwise extending forward end surfaces thereof against which the front end of the plate 312 abuts, with the plate 312 received in the upper pocket and the side plates 306 and 308 assembled.

The plates 306 and 308 can be optimized in terms of their weight and manufacturability by the provision of various windows, cut-outs and reliefs formed in their main surfaces 330 and 332 as well as in raised wall portions 322-328. As shown, the front wall portions 322 and 324 include a pair of window openings 369a to provide them with an efficient high-strength, ribbed construction. The upper wall portions 326 and 238 each also include a window openings 369a as well as a cut-out opening 369b. The window openings 369a and cut-outs 369b in each plate 306 and 308 are aligned from corresponding openings 369a and 369b in the other plate 306 or 308. In practice, the weight of the plates 306 and 308 formed from a magnesium material is approximately 0.278 lbs each, which provides the tool head portion 304 with a significant weight reduction over corresponding steel head portions of prior tools, as previously has been discussed.

An anvil 370 is fixedly mounted at the bottom, nose ends of the side plates 306 and 308 via a rearwardly opening clevis portion 372 at the upper end of the anvil 370. Pin member 374 extends between the bottom ends of the plates 306 and 308 for locating the anvil 370 with the pin 374 received between upper and lower legs 372a and 372b of the clevis portion 372, as shown in FIG. 31. With the anvil 370 so mounted, lower curved anvil surface 376 is facing upwardly, generally aligned with the clip driver 18, as can be seen in FIG. 29.

While there have been illustrated and described particular embodiments of the present invention, it will be appreciated that numerous changes and modifications will occur to those skilled in the art, and it is intended in the appended claims to cover all those changes and modifications which fall within the true spirit and scope of the present invention.

What is claimed:

1. A power tool for driving fasteners, the power tool comprising:
a driver that shifts from a retracted position to an extended position for engaging and driving the fasteners;
a piston operably connected to the driver, the piston being fluid driven so that shifting the piston shifts the driver to the extended position thereof;
a housing member having an internal space in which the piston is shifted and including an open end thereof;
a cap member for closing the open end of the housing member;
a valve member that governs admission of fluid to the housing member internal space for driving of the piston therein by shifting between fluid intake and fluid exhaust positions thereof; and
guide surfaces in the housing member and the cap member that guide shifting of the valve member between the intake and exhaust positions so that shifting of the valve member is in both the housing member and the cap member to keep size of the cap member to a minimum.

2. The power tool of claim 1 wherein the valve member shifts in an axial direction, and the cap member size is minimized in the axial direction.

3. The power tool of claim 1 wherein the internal space of the housing member has a fluid chamber to which fluid is admitted for driving the piston, the cap member has a fluid path leading from the fluid chamber to the valve member with the cap member being configured with a low profile so that the fluid path extends generally straight across in the cap and to the valve member to minimize directional changes in fluid flow in the cap member fluid path.

4. The power tool of claim 1 wherein the housing member and the cap member form an exhaust port therebetween through which fluid exits as the driver is shifted from the extended to the retracted position thereof.

5. The power tool of claim 1 wherein the guide surfaces in the housing and cap members are integral annular surfaces having large predetermined radii to maximize fluid flow permitted by the valve member.

6. The power tool of claim 5 wherein the valve member includes a radially enlarged end that is maximized in size to ride against the large annular guide surface of the cap member.

7. The power tool of claim 1 wherein the valve member includes a stem and an enlarged annular head at one end of the stem that rides against the guide surface in the housing member, and the housing member includes an internal pocket so that the guide surface of the housing member in which the annular head is disposed is integral with the housing member.

8. The power tool of claim 1 wherein the valve member has opposite ends with one end disposed in the cap member and the other end disposed in the housing member.

9. The power tool of claim 1 wherein the valve member is a main valve member, and
a trigger actuator and a control valve that is shifted by operation of the trigger actuator to cause the main valve member to shift to the fluid intake position thereof.

10. The power tool of claim 1 wherein the fasteners are clips, and
a clip magazine for retaining a plurality of clips and having a discharge end for feeding a leading one of the clips into position so that the driver engages the clip during shifting to the extended position thereof.

11. A pneumatic clipping tool for clinching clips about wires to hold the wires together, the clipping tool comprising:
a housing assembly having opposite ends;
an air line coupling at one of the ends of the housing assembly that allows an air line to be attached thereto for supplying the housing assembly with pressurized air;
a piston in the housing assembly having a driving stroke which shifts the piston from adjacent the one housing end toward the other housing end;
a clip driver configured to drive the clips for clinching about wires with the piston undertaking a driving stroke and the driver shifted between retracted and extended positions thereof;
an actuator operable to cause the piston to undertake the driving stroke and the driver to shift to the extended position for clip driving;
an air admission valve member adjacent the coupling for being shifted between an air intake position to allow pressurized air into the housing assembly for driving the piston toward the other end of the housing assembly and an air exhaust position to seal the coupling against pressurized air intake into the housing assembly with the piston shifting back toward the one end of the housing assembly; and
guide surfaces of the housing assembly and integral therewith for guiding shifting of the valve member between the air intake and air exhaust positions obviating the need for a distinct valve member body to keep the weight of the housing assembly to a minimum.

12. The pneumatic clipping tool of claim 11 wherein the housing assembly includes a main housing member in which the piston is disposed and a cap member including the air line coupling with the guide surfaces integrated in both the main housing member and the cap member with shifting of the air admission valve member occurring in both the main housing member and the cap member.

13. The pneumatic clipping tool of claim 11 wherein the housing assembly includes an air chamber between the piston and the one end of the housing assembly and an internal inlet port to the air chamber with the valve member allowing the pressurized air to flow between the air coupling and the air chamber through the inlet port in the air intake position thereof, and
an internal surface of the air line coupling having a predetermined diameter that is unobstructed for maximizing intake air flow therethrough and providing high speed driving strokes of the piston.

14. The pneumatic clipping tool of claim 11 wherein the housing assembly includes a main housing member in which the piston is driven and a cap member attached to the main housing assembly at the one end of the housing assembly, and
a gap formed between the main housing member and the cap member at a predetermined aligned position about the housing and cap members to form an outlet port for exhausting air from the housing assembly as the piston is shifted in a return stroke opposite to the driving stroke with the valve member in the air exhaust position.

15. The pneumatic clipping tool of claim 14 wherein the cap member has a low profile and defines an exhaust air flow path that extends generally straight across the cap member to the outlet port.

16. The pneumatic clipping tool of claim 11 wherein the valve member includes a stem having an enlarged annular head at one end thereof, and the housing assembly includes an internal shoulder integral therewith against which the head abuts with the valve member in the air exhaust position.

17. The pneumatic clipping tool of claim 11 including a head portion in which the driver is shifted with the head portion being forwardly of the housing assembly to allow an operator to grip the tool generally between the housing assembly and the head portion for operating the actuator, the head portion including side plates and at least one high strength bearing plate insert therebetween for distributing loading caused by the driving forces with shifting of the driver and allowing the side plates to be of a light weight material to balance the head portion with the light weight of the housing assembly for optimized tool ergonomics.

18. A pneumatic, hand-held power tool for driving fasteners, the power tool comprising:
a cylinder assembly including a pneumatically driven piston;
a head portion including a driver for being advanced to drive the fasteners;
a toggle-link between the piston and the driver to provide a mechanical advantage for increasing output force of the driver over that of the driven piston;
outer walls of the head portion that are generally of a predetermined light weight material; and
a bearing insert of the head portion having a substantially solid internal wall including a large bearing surface against which the advancing driver rides, the bearing insert being of a predetermined high strength material different from the light weight outer wall material to distribute loading from the driver about the large bearing surface before transfer to the light weight outer walls to minimize weight of the head portion.

19. The power tool of claim 18 wherein the head portion includes a pair of light weight side plates secured together to form the head portion outer walls.

20. The power tool of claim 19 wherein the side plates cooperate to form an internal pocket, and the bearing insert has a flat plate configuration for fitting in the pocket.

21. The power tool of claim 19 wherein the bearing insert has a T-shape cross-sectional configuration for being clamped between the side plates with the bearing surface facing the driver for engagement therewith.

22. The power tool of claim 19 wherein the side plates include respective front wall portions, top wall portions, and corner wall portions integrally connecting the front and top wall portions.

23. The power tool of claim 18 wherein piston includes a rod extending in a direction transverse to the driver and a roller pivotally attached to the toggle link, and the bearing insert is a forward bearing insert having the bearing surface extending transverse to the direction of the piston rod, and
a top bearing insert having a substantially solid internal wall including a bearing surface generally extending in the direction of the piston rod and having the roller engaged thereagainst as the piston is driven.

24. The power tool of claim 18 wherein the predetermined material of the outer walls is a light weight magnesium material, and the predetermined material of the bearing insert is a high strength steel material.

25. The power tool of claim 18 wherein the cylinder assembly generates a predetermined force of approximately 900 lbs., and the driver has an increased output force of approximately 2500 lbs.

26. The power tool of claim 18 wherein the cylinder assembly is disposed rearwardly of the head portion and includes a cap member and a housing member in which the piston is disposed,
an intermediate gripping portion between the rear cylinder assembly and the forward head portion, and
an air admission valve member that shifts for regulating air flow to drive the piston with the valve shifting occurring in both the cap member and the housing member to keep size and weight of the cap member to a minimum for balancing the rear cylinder assembly with the light weight forward head portion for optimized tool ergonomics.

27. A power tool for applying clips to wires, the power tool comprising:
a rear cylinder assembly including a piston that is driven therein;
a fluid admission valve member that is shifted between an intake position with the piston driven forwardly and an exhaust position with the piston driven rearwardly;
guide surfaces for the valve member integrated into the cylinder assembly to minimize weight thereof;
a forward head portion including a drive assembly having a clip driver that is advanced for clenching a clip about wires as the piston is driven;
outer walls of the head portion of a predetermined light weight material to generally weight balance the forward head portion with the rear cylinder assembly; and
an insert of the head portion having a bearing surface against which the driver rides as it is extended to distribute drive forces generated by the drive assembly including the driven piston there across.

28. The power tool of claim 27 wherein the driver is extended in a transverse direction to travel of the piston as it is driven, and the drive assembly includes a toggle link between the piston and driver that provides a camming action therebetween so that driver output force is increased over that of the driven piston with the insert arranged forwardly of the driver to take the loading generated by the camming of the driver thereagainst.

29. The power tool of claim 28 wherein the piston includes a rod and the toggle link is connected to the piston rod by a roller, the forward insert being of a high strength material different from the wall light weight material, and
an upper insert of a high strength material different from the wall light weight material along which the roller rolls as the piston is driven.

30. The power tool of claim 27 wherein the rear cylinder assembly includes a main housing member and a cap member connected to the housing member with the guide surfaces for the valve member integrated into both the housing and cap members so that valve member shifting occurs in both to keep the weight of the cap member to a minimum.
